(19) United States
(12) Patent Application Publication
(10) Pub. No.: US 2026/0312301 A1
(43) Pub. Date: Oct. 8, 2026

(54) MODULE CONNECTOR FOR ELECTRICALLY CONNECTING TO A MODULE POLE CONNECTION OF A BATTERY MODULE, MODULE POLE CONNECTION AND CONNECTING ASSEMBLY

(71) Applicant: AUDI AG, Ingolstadt (DE)

(72) Inventor: Bernd ROLL, Schwäbisch Hall (DE)

(73) Assignee: AUDI AG, Ingolstadt (DE)

(21) Appl. No.: 19/484,605

(22) PCT Filed: May 7, 2024
(86) PCT No.: PCT/EP2024/062595

§ 371 Date: Nov. 14, 2025

(30) Foreign Application Priority Data
May 16, 2023 (DE) 102023112889.2

(51) Int. Cl. H01R 4/34; H01R 4/70; H01R 11/26; H01R 11/28

(52) U.S. Cl. CPC H01R 4/34; H01R 4/70; H01R 11/26; H01R 11/281

(57) ABSTRACT

A module connector for electrically connecting to a module pole collection in a connecting direction. The module connector has a busbar with a busbar through-opening and a contact socket having an end face with a contact surface for electrically contacting the module pole connection. The contact socket has a socket opening arranged below the busbar and coaxially aligned with the busbar through-opening with respect to the connecting direction, so that a fastener can be passed through the busbar through-opening and the socket opening simultaneously in the connecting direction. The module connector has a housing with an insulation collar surrounding at least part of the busbar and at least part of the contact socket in a radial direction. The insulation-free socket part of the contact socket protrudes from the housing in the connecting direction.

### FIELD

The invention relates to a module connector for electrically connecting to a module pole connection of a battery module by producing a plug connection in a connecting direction, wherein the module connector has an electrically conductive busbar with a busbar through-opening for passing through a fastening means in the connecting direction and an electrically conductive contact socket which has an insulation-free socket part with an insulation-free end face which provides a contact surface for electrically contacting the module pole connection, and wherein the contact socket has a socket opening which is arranged below the busbar with respect to the connecting direction and is aligned coaxially with the busbar opening, so that the fastening means can be passed through the busbar through-opening and the socket opening simultaneously in the connecting direction. In addition, the module connector comprises an electrically insulating housing with an insulation collar that surrounds at least part of the busbar and at least part of the contact socket in a radial direction. Furthermore, the invention also relates to a module pole connection and a connecting assembly.

### BACKGROUND

To protect people against electric shock, touch protection is advantageous at the electrical interface of high-voltage batteries, the module pole and their electrical connecting elements, which are also referred to as high-voltage connectors and in this case as module connectors, in order to simplify installation or to enable installation without special protective clothing. Typically, touch protection of existing connection systems is implemented using multiple special components such as protective pins, contact sleeves, electrically insulating collars or caps on the two interface partners.

For example, DE 20 2018 100 111 U1 describes a module connector with two connecting parts which can be connected to one another in an electrically conductive manner, to each of which a conductor element can be attached at a conductor point, and which each have a mutually compatible fastening element, wherein each connecting part is provided on its connection side facing the other connecting part with a contact guard which has an outer electrically insulating collar and an electrically insulating protective pin surrounded by the collar, wherein in at least one connecting part between the collar and the protective pin there is a current bridge which electrically connects the two conductor points and is projected over by the collar and the protective pin, wherein the current bridge is designed as a contact sleeve.

To provide touch protection, contact elements are often radially surrounded by insulation collars which project over them. This usually requires a complex design of both interface partners to be connected and also requires a lot of installation space in the connecting direction, since the corresponding insulating parts have to protrude far beyond the contact surfaces in order to provide a corresponding touch protection. A similar connecting assembly is also described in EP 3 419 119 B1, DE 10 2020 212 760 A1 and DE 10 2020 208 149 A1.

Furthermore, DE 10 2020 100 919 A1 describes a touch-protected rotary contact with a busbar, with a connecting screw which has a threaded portion and a fastening portion and extends through a busbar recess in the busbar from a first side to a second side of the busbar along a connecting axis in a connecting direction. An insulation element is arranged in the connecting direction between the busbar and the connecting screw, whereby the connecting screw is electrically insulated from the busbar.

Such insulation elements are typically made of plastic. The disadvantage of plastics, especially when used in screw connections, is that they begin to creep over time, causing the screw connection to loosen. Especially when electrically connecting high-voltage connections, this has the major disadvantage that the resulting increased contact resistance leads to large line losses and additional heating of the busbar, which has a detrimental effect on the operation of the battery modules.

### SUMMARY

The object of the present invention is to provide a module connector, a module pole connection and a connecting assembly which enable the most efficient and simple design possible.

This object is achieved by a module connector, a module pole connection and a connecting assembly. Advantageous embodiments of the invention are the subject matter of the description, and the figures.

A module connector according to the invention for electrically connecting to a module pole connection of a battery module by producing a plug connection in a connecting direction, wherein the module connector has an electrically conductive busbar with a busbar through-opening for passing through a fastening means in the connecting direction and an electrically conductive contact socket which has an insulation-free socket part with an insulation-free end face which provides a contact surface for electrically contacting the module pole connection, wherein the contact socket has a socket opening which is arranged below the busbar with respect to the connecting direction and is aligned coaxially with the busbar opening, so that the fastening means can be passed through the busbar through-opening and the socket opening simultaneously in the connecting direction. The module connector further comprises an electrically insulating housing with an insulation collar that surrounds at least part of the busbar and at least part of the contact socket in a radial direction. The insulation-free socket part of the contact socket, which comprises the end face with the contact surface, protrudes from the housing in the connecting direction.

This means that the insulation-free socket part of the contact socket, which comprises the end face with the contact surface, is in principle designed to be touchable. The invention is based on several findings: Firstly, the invention makes use of the finding that there are installation situations in which no touch protection needs to be provided by the module connector itself, since, for example, in such an installation situation, due to the installation space, there is no possibility of touching the insulation-free, protruding socket part anyway. In other words, the installation situation itself can provide appropriate touch protection, which then does not have to be additionally implemented by the module connector itself. Furthermore, the invention is based on the finding that module connectors are used to connect two module poles of two battery modules. As long as such a module connector is not connected to any of these module poles, there is no voltage present on the busbar. Even in this situation, there is no need to provide touch protection, since the insulation-free part of the contact socket is not live anyway. Installation on a first module pole connection is therefore particularly easy. In the assembled state, i.e. when the module pole connection is connected and fastened to the module connector as intended, sufficient and complete touch protection is ensured by the electrically insulating housing of the module connector and/or by a corresponding electrically insulating housing of the module pole connection. Furthermore, the invention is based on the finding that it is possible to optionally design the contact socket to be electrically insulated from the busbar, at least in the non-assembled state, as will be explained in more detail later. In this case, the contact socket is also not live, as there is no contact with the busbar, and therefore does not need to be additionally touch-protected. These findings in turn make it possible to design the contact socket in such a way that the insulation-free socket part with the end face and the contact surface protrudes from the housing. This in turn has the great advantage that the contacting to the module pole connection and, above all, the structural design of the module pole connection itself is significantly simplified. This thus means that the contact surface protruding from the housing can be inserted much more easily into a corresponding recess provided by the module pole connection in order to close the electrical contact with a corresponding second contact surface of the module pole connection. The recess can be provided, for example, by a small opening in the second housing of the module pole connection in order to expose regions of the module pole busbar accommodated in this second housing. Insulation collars that protrude very far in the axial direction can be dispensed with both on the module connector side and on the module pole connection side, which in turn can save enormous installation space in the axial direction. All this enables a particularly simple yet efficient design of a module connector, as well as in particular the corresponding module pole connection.

The module connector is used to electrically connect two module poles of two battery modules. Each of these module poles can be designed with a corresponding module pole connection. The two module poles can then be electrically connected via the busbar if the module connector is properly coupled to these module pole connections. When the module connector is in its intended operation, current is therefore conducted from one battery pole to another battery pole of another battery module via the busbar. The module connector is also preferably used in the high-voltage range. The module connector can be designed to carry very high currents. Furthermore, the module connector can, for example, have a first connection region which comprises a part of the electrically conductive busbar with the busbar through-opening, as well as the electrically conductive contact socket with the socket opening and the insulation collar. In addition, the module connector can have another such connection unit, i.e. an additional second connection unit, which in principle can be designed in a completely analogous manner to that described for the first connection unit. The first connection unit can then, for example, be electrically contacted with a first module pole connection and the second connection unit in a corresponding manner with a second module pole connection. The two connection units are then connected to each other by a middle part of the busbar and a part of the housing that encloses the middle part of the busbar. The electrically insulating housing may be made of an electrically insulating material, for example a plastic. This also applies to all electrically insulating components described below. The busbar is made of an electrically conductive material, in particular a metallic material, for example copper. The busbar through-opening can be designed as a hole in the busbar. This is preferably circular in shape. The socket opening can also be designed as a hole in the contact socket. The socket opening also preferably has a circular cross-section perpendicular to the connecting direction. The contact socket can be designed as a metallic ring-shaped component with a central through-opening that provides the socket opening. The contact socket can also be called a contact sleeve, for example. In principle, the contact socket, especially on the outer circumference, can be designed with any geometry, e.g. also a polygonal geometry.

The connecting direction is defined in such a way that a plug connection between the module connector and a corresponding module pole connection is possible by plugging these two components together in this connecting direction. The connecting direction can also correspond to an axial direction or run parallel to an axial direction that runs through a center of the busbar through-opening and the socket opening. The axial direction extends essentially parallel to an axis of the fastening means, which can be passed through the corresponding through openings. A radial direction is correspondingly perpendicular to this axial direction and directed away from such a central axis passing through the corresponding through-openings. The insulation-free end face with the contact surface is preferably designed to be flat or planar. The end face lies, so to speak, in a plane perpendicular to the axial direction. This allows a surface contact to be established with the corresponding second contact surface of the module pole connection. By using a fastening means, which will be explained in more detail later, this contact can be fixed and, above all, the corresponding contact surfaces can be pressed together with high contact force.

In a particularly advantageous embodiment of the invention, the module connector has an elastic spring element which is compressible and/or expandable in the connecting direction, wherein the module connector can be transferred from a first state to a second state, wherein in the first state the contact socket is held at a distance from the busbar and electrically insulated from it by means of the spring element and in the second state rests against the busbar in an electrically contacting manner under compression of the spring element.

This design has the great advantage that even if the busbar is already energized, the contact socket is voltage-free since it is kept electrically insulated from the busbar in the first state. In the first state, there is thus no electrically conductive contact between the contact socket and the busbar. In the second state, however, this contact is present, which makes it possible to conduct electrical current via the busbar and the contact socket to the module pole connection or analogously in the opposite direction, depending on the current direction. By means of the spring element, the contact socket can advantageously be kept at an appropriate distance from the busbar in order to maintain the electrical insulation between these components. The contact socket does not need to have an electrically insulated design, as it has no electrically conductive connection to the busbar. This is only established when the module connector is already arranged as intended on the module pole connection, so that in this situation the touch protection is already provided by the housing of the module connector and/or that of the module pole connection, and touching the contact socket is no longer possible in this situation anyway.

In a further advantageous embodiment of the invention, the module connector comprises an insulating sleeve made of an electrically insulating material, wherein the insulating sleeve is arranged in the busbar through-opening, in particular on an opening wall delimiting the busbar through-opening in the radial direction, wherein the fastening means is electrically insulated from the busbar by means of the insulating sleeve in a state in which it is passed through the busbar through-opening. The fastening means can also advantageously be passed through the busbar in an electrically insulated manner. An electrically conductive contact between the fastening means and the contact socket is then unproblematic, since the fastening means can also be easily designed to be electrically insulated from the busbar.

Another great advantage of the insulating sleeve used, which is in particular also made of an electrically insulating material, for example a plastic, is that also the spring element can be passed through the busbar through-opening in an electrically insulated manner from the busbar.

The insulating sleeve is generally optional and electrical insulation can be provided in other ways, if necessary at all. The insulating sleeve is advantageous, for example, if the spring element is made of an electrically conductive material. The insulating sleeve, however, is not necessary if the spring element and/or the busbar through-opening have an electrically insulating coating and/or the spring element is made of a non-electrically conductive material.

Therefore, it is a further very advantageous embodiment of the invention that the spring element is designed as a spiral spring which is passed through the busbar through-opening and is electrically insulated from the busbar by means of the insulating sleeve. The spring element is preferably also made of a metallic material. As a result, it is subject to significantly less fatigue over its lifetime. Due to the possibility of electrically insulating the spring element from the busbar in a simple manner, the spring element itself can also advantageously be made of a metallic material. The design of the spring element as a spiral spring is also very advantageous. On the one hand, this is possible in a particularly simple and cost-effective manner, and on the other hand, it allows a particularly simple and efficient, space-saving arrangement of the spring element, which, as a spiral spring, can also run around a neck of the fastening means, for example. In other words, the fastening means can be passed through the spiral spring. For example, the spiral spring surrounds the neck of the fastening means in the radial direction, wherein the spiral spring is in turn initially surrounded in the radial direction by the insulating sleeve at the level of the busbar, to which the busbar is then connected in the radial direction.

In a further advantageous embodiment of the invention, the contact socket has a radially inwardly projecting support flange on which the spring element is supported in the connecting direction with a first spring end. As described in more detail below, the other second spring end can be supported on a screw head or generally on a widened part of the fastening means. The spring element or the spiral spring can therefore first be passed through the busbar through-opening and the insulating sleeve in the connecting direction and inserted a little way into the socket opening of the contact socket, namely up to the support flange against which the first spring end rests. The spring element is therefore not completely passed through the socket opening. In particular, the spring element does not protrude from the underside of the socket opening in the connecting direction. In the radial direction, the spring element is partially supported by the inner wall of the socket opening and by the insulating sleeve within the busbar through-opening. This advantageously prevents lateral slippage even under mechanical tension.

The first state of the module connector can, for example, be defined in such a way that in this state the spring element is in a relaxed state, i.e. the spring element is not or hardly under mechanical stress. To transfer the module connector into the second state, the spring element is compressed accordingly in the connecting direction. In the second state, the spring element is under mechanical load. It is also conceivable that the spring element is partially under mechanical load when the module connector is in the first state. However, the mechanical stress is then considered to be lower than in the second state of the module connector, since the mechanical stress is then additionally increased by compression of the spring element.

Furthermore, it is very advantageous if the insulation collar also has a radially inwardly projecting mounting flange and the contact socket has a radially outwardly projecting support flange which rests on the mounting flange, whereby the contact socket is held on the housing and cannot be moved out of the housing in the connecting direction. The maximum diameter of the support flange is therefore larger than the inner diameter of the mounting flange. This means that the contact socket can be advantageously held within the insulation collar. Falling out is then advantageously not possible. The spring element also presses the contact socket onto the mounting flange of the insulation collar. In other words, moving the support flange away from the support flange increases the tension force of the spring. The spring element can therefore further stabilize the position of the contact socket.

In a further advantageous embodiment of the invention, the module connector has the fastening means which comprises a fastening means which is elongated in the connecting direction and has a head and a neck which adjoins the head in the connecting direction, wherein the neck is passed through the busbar opening and the socket opening, and wherein the fastening means has an end opposite the head, which in particular protrudes from the housing in the connecting direction. The fastening means can, for example, be designed as a screw. The head then represents a screw head that is wider than the screw neck, while the screw neck corresponds to the neck of the fastening means. Such a screw can, for example, be provided with an external thread. This extends over at least a section of the screw neck. The module pole connection can be designed with a corresponding nut into which the screw of the module connector can be screwed. However, it is also conceivable to be the other way around, namely that, for example, the neck of the fastening means is designed with an internal thread into which a screw can be screwed as part of the module pole connection. In any case, it is advantageous if the fastening means is elongated in the connecting direction and has a head which is wider than the neck. The head prevents slipping through the aforementioned openings, namely the busbar through-opening and the socket opening.

In a further very advantageous embodiment of the invention, in the first state of the module connector, the head is held at a distance from the busbar and insulated from the busbar by means of the spring element, and in the second state the head is electrically conductively connected to the busbar, in particular the head lies directly on the busbar, or the module connector comprises a metallic washer which is arranged between the head and the busbar and via which the head and the busbar are electrically conductively connected to one another in the second state. Similarly to what has been described for the contact socket, the fastening means can therefore also be electrically insulated from the busbar in the first state, while in the second state an electrically conductive contact is established between the fastening means and the busbar. This is again achieved by the same spring element as already described. This, in turn, has several, particularly numerous, advantages: Firstly, for example, the end of the fastening means opposite the head does not have to be electrically insulated or provided with an electrically insulating protective cap or similar, even if it protrudes from the underside of the housing of the module connector. This also simplifies the structural design, because an electrically conductive contact between the fastening element and the contact socket, for example via the spring, is then also unproblematic. A particularly great advantage of this design is that the fastening means and in particular the head are not permanently electrically insulated from the busbar, for example by means of a plastic washer between the head and the busbar. This avoids the resulting disadvantages described at the beginning, namely that plastic insulation in screw connections does not last long due to the high forces and leads to a loosening of the connection due to the creep behavior of the plastic. By means of these configurations, which have been described within the scope of the invention, hard screw joints can advantageously be realized without any intermediate plastic parts as part of such a screw connection. In the second state, in which the fastening means is electrically connected to the busbar or is in contact with it, the screw head, for example, rests directly on the busbar or it rests directly on a metal washer, which in turn rests directly on the busbar. This allows a particularly stable and, above all, permanently stable screw connection to be created. An increase in the contact resistance in the current-carrying components can thus advantageously be avoided or at least contact resistance can be minimized.

In a further advantageous embodiment of the invention, the contact socket is arranged in a permanently electrically contacting manner on the busbar and/or is formed integrally therewith and, in particular, the fastening means is also permanently electrically conductively connected to the busbar. According to this embodiment, the spring element described above can be dispensed with. In this embodiment, the contact socket as well as the fastening means are in a permanent contact state with the busbar. If there is voltage on the busbar, the contact socket and the fastening means are also under voltage. This embodiment has the advantage that it enables a particularly simple design of the module pole connection, as is also possible with the previously described variants of the module connector with the spring element, and at the same time also enables an even simpler design of the module connector itself. This design of the module connector is particularly suitable when, for example, the installation situation means that no contact with the contact socket is possible at all, so that corresponding touch protection can be dispensed with, or in a corresponding installation situation the busbar is not yet energized, so that here too no touch protection for the contact socket is required.

As described above, a module connector can have two connection units, one of which can be coupled to a corresponding module pole connection of a respective battery module. These two connection units of the module connector can also be designed differently. One of these connection units can, for example, be designed with a contact socket that permanently contacts the busbar, and the other of the two connection units can instead be designed with a spring element that keeps the contact socket at an electrically insulating distance from the busbar in the first state of the module connector and only establishes electrical contact with the busbar after transfer to the second state. The various embodiments described in connection with the module connector can therefore also be combined by a single module connector.

In a further advantageous embodiment of the invention, the spring element has a second spring end which is supported on the head of the fastening means and/or on the washer, in particular wherein the spring element is compressible by moving the head of the fastening means in the connecting direction, while the contact socket remains in its position, and the module connector can be transferred from the first state to the second state. This has the great advantage that the module connector is automatically transferred from the first to the second state as soon as the module connector is attached to the corresponding module pole connection using the fastening means. If thus the fastening means is a screw, the module connector is automatically transferred from the first to the second state by screwing this screw into a corresponding nut of the module pole connection, since screwing in the screw moves the screw head in the connecting direction and, in particular, in the direction of the contact socket, while the latter remains in its position by contacting a corresponding contact element of the module pole connection. The head is therefore moved in the direction of the contact socket by the screwing movement, whereby the spring stretched between the screw head and the contact socket is compressed and thus tensioned or additionally tensioned. The screw can be screwed in until the screw head finally has electrical contact with the busbar, in particular by directly resting on the busbar or via the washer, and until the contact socket also has direct electrical contact with the busbar. In this second state, the spring does not have to be in its maximum compressed state. Preferably, the second state is reached before the spring has reached its maximum compressed state. Thus, the electrical contact between the contact socket and the busbar can be ensured in the second state in any case.

Furthermore, the invention also relates to a module pole connection for electrical connection to a module connector according to the invention or one of its embodiments. The module pole connection according to the invention is thus designed to be electrically coupled to a previously described module connector and to be electrically connected thereto.

The module pole connection has a module pole busbar with a contact region that can be electrically contacted with the contact surface of the module connector in the connecting direction, and a housing that is electrically insulating and in which the module pole busbar is accommodated, wherein the housing has a housing wall that has a recess region with at least one recess for exposing at least part of the contact region of the module pole busbar, wherein the housing wall has a recess edge region that surrounds the recess region in a radial direction, and wherein the housing wall comprises an electrically insulating insulation ring radially inside the recess region, which is connected to the recess edge region via at least one insulation web.

This enables a particularly simple and advantageous and, above all, space-efficient design of the module pole connection.

By providing at least one insulation web extending from a central insulation ring to the recess edge region of the housing surrounding the recess region, it is possible to reduce the effective recess region or to subdivide it into individual segments, whereby touch protection can advantageously also be provided, in a significantly more space-saving manner than, for example, in the form of a circumferential insulation collar projecting far in the axial direction or a central insulating pin projecting far in the axial direction or the like. In order to be able to make contact with this module connection, the corresponding module connector can have a slot or a slot-shaped recess on the end face of the contact socket corresponding to at least one web. If such a module connector and a corresponding module connection are electrically connected to each other, at least one electrically insulating insulation web is located in this slot of the module connector. A twisting between the module connector and the module connection is then no longer possible or not possible up to a certain torque, since the insulation web counteracts this torque. This in turn means that a screw connection between such a module connection and the corresponding module connector can be carried out with a significantly higher torque, which in turn allows a significantly stronger contact force to be achieved between the contact surfaces of the module connection and the module connector. This also leads to minimization of contact resistance and increased efficiency. This also reduces the heat input into the cell module, which in turn has a positive effect on service life and performance. This can also provide a significantly more stable connection between such a module connection and the corresponding module connector over its lifetime. Another major advantage is that no additional, separate contact with the contact region of the module pole busbar is required to ensure a corresponding elevation. Such an elevation is not necessary since the module connector is designed with a contact socket that protrudes from the housing. In general, a particularly simple module pole connection can be provided here, which nevertheless makes it possible to provide touch protection and at the same time does so in a particularly space-saving and efficiency-enhancing manner.

An insulation web is generally understood to be an elongated component made of an electrically insulating material. In particular, the recess edge region surrounding the recess region directly adjoins the recess region in the radial direction. The recess edge region delimits the recess region in the radial direction, so to speak. The recess region represents the region of the housing wall in which the at least one or more recesses are arranged, in particular in the radial direction around the insulation ring. The recess region can be defined by the totality of the recesses. The recesses can be separated by insulating webs. This means that the recess region does not have to be a continuous region. The recess region can also be defined in such a way that, in addition to the recesses, it also comprises the at least one or multiple insulation webs. In this case, the recess region is a continuous region through which the at least one insulation web passes.

The housing wall can be essentially flat. This may have a slight elevation in the region of the insulation ring, the recess edge region and the at least one insulation web, but the insulation ring, the insulation web and the recess edge region do not have to be significantly elevated above a base plane of the housing wall in order to provide touch protection. The insulation ring, the at least one insulation web and the recess edge region can therefore be elevated relative to the base plane of the housing wall, whereby this elevation is, for example, of the same order of magnitude as the thickness of the housing wall in a non-elevated region. In other words, the housing wall in the region of the insulation ring, the insulation web and the recess edge region can be approximately twice as thick as in the adjoining regions of the housing wall radially outside the recess edge region. The elevation is therefore particularly small overall. Rather, touch protection can be provided by reducing the opening in the housing wall, which must be penetrated in order to come into contact with the contact region, by providing the at least one insulation web. The insulation ring of the housing wall surrounds a circular opening, in particular a central circular opening. A fastening means, for example a screw, can be inserted into this to fix the module pole connection to the corresponding module connector. Therefore, no additional insulation pin that is elevated axially far above the base plane of the housing wall needs to be provided within the insulation ring. This also saves a lot of installation space.

The module pole connection can be part of a battery module. A battery module, in particular for a high-voltage battery of a motor vehicle, can have two such module pole connections. Each of these two module pole connections can be assigned to one of the two potentials of such a battery module, namely a positive potential and a negative potential. A high-voltage battery for a motor vehicle can comprise multiple battery modules. These can be electrically connected to each other via appropriate module connectors and wired accordingly. For this purpose, for example, a first module pole connection of a first battery module can be electrically connected to a second module pole connection of a second battery module via such a module connector.

The at least one recess is designed as an opening in the housing wall. In other words, a recess is understood to be an opening in the housing wall. As a result, when the module pole busbar is in a state in which it is accommodated in the housing as intended, the contact region of this busbar is accessible from outside the housing through this recess and can thus be contacted by a corresponding second contact region of the module connector.

By providing at least one insulation web, it is now possible not only to provide a single, closed, ring-shaped recess in the recess region, but also to subdivide and divide this recess into multiple recess segments, for example. The individual recesses can thus be significantly reduced in size. This can, for example, increase the touch protection, but also the maximum torque that can be supported by the individual insulation webs as a whole.

Furthermore, the invention also relates to a connecting assembly for a battery module, wherein the connecting assembly comprises a module connector according to the invention or one of its embodiments, as well as a module pole connection according to the invention or one of its embodiments.

The advantages mentioned also apply similarly to the connecting assembly according to the invention and its embodiments.

Furthermore, the invention also relates to a battery for a motor vehicle, in particular a high-voltage battery which comprises a connecting assembly according to the invention or one of its embodiments. The battery can also have one or multiple battery modules. The battery modules can in turn comprise one or more battery cells.

Furthermore, the invention also relates to a motor vehicle with a battery according to the invention or one of its embodiments.

The invention also includes refinements of the module pole connection according to the invention and of the connecting assembly according to the invention, which have features as already described in the context of the refinements of the module connector according to the invention. For this reason, the corresponding developments of the module pole connection according to the invention and of the connecting assembly according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

Exemplary embodiments of the invention are described hereinafter. In particular:

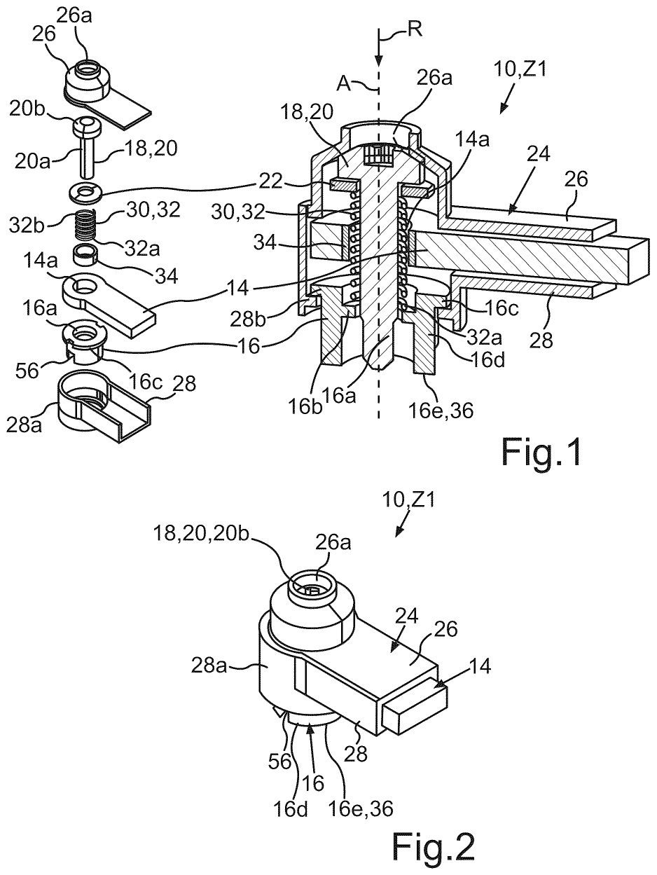

FIG. 1 shows a schematic representation of a module connector according to an exemplary embodiment of the invention;

FIG. 2 shows a schematic and perspective representation of the module connector from FIG. 1;

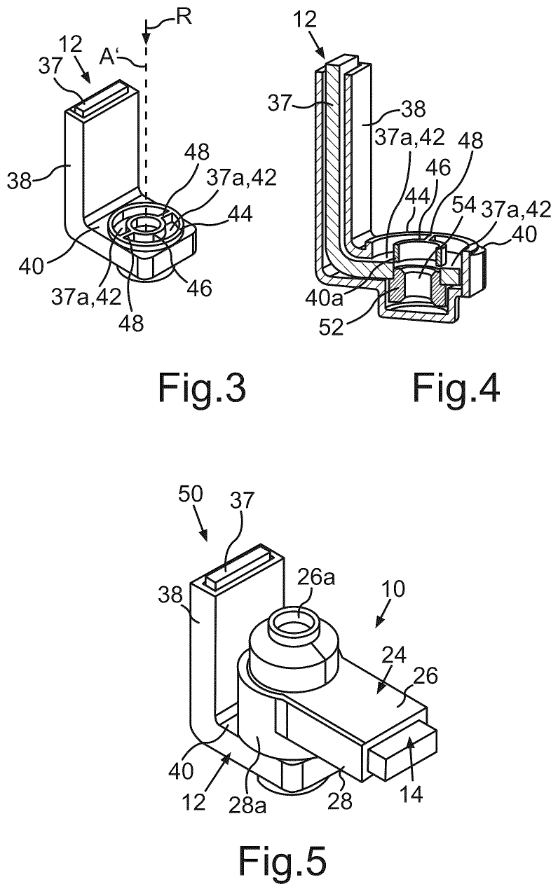

FIG. 3 shows a schematic and perspective representation of a module pole connection according to an exemplary embodiment of the invention;

FIG. 4 shows a schematic cross-sectional representation of a module pole connection of FIG. 3 according to an exemplary embodiment of the invention;

FIG. 5 shows a schematic and perspective representation of a connecting assembly with a module pole connection and a module connector according to an exemplary embodiment of the invention;

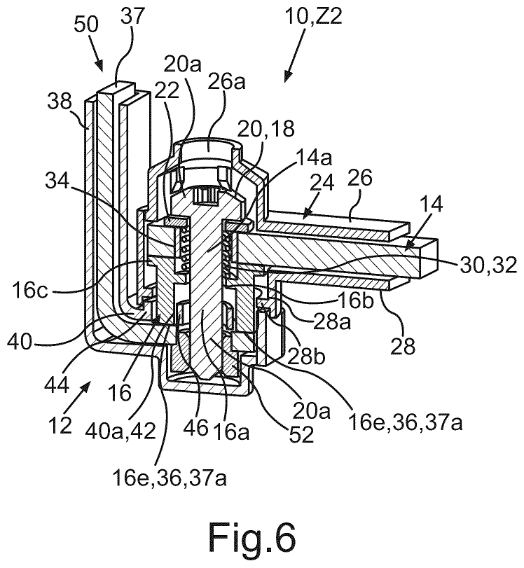

FIG. 6 shows a schematic cross-sectional representation of the connecting assembly of FIG. 5 according to an exemplary embodiment of the invention;

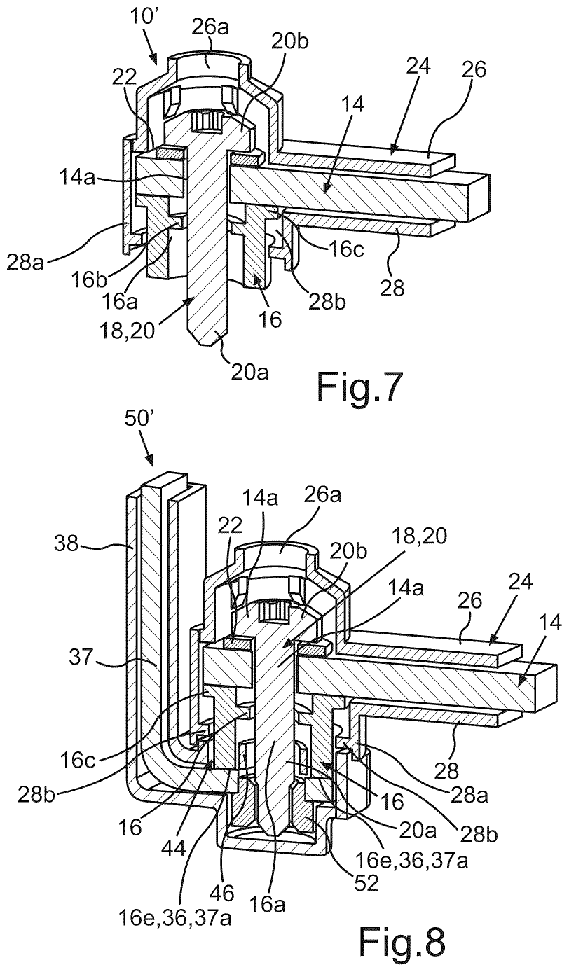

FIG. 7 shows a schematic cross-sectional representation of a module connector arrangement according to another exemplary embodiment of the invention; and

FIG. 8 shows a schematic representation of a connecting assembly with the module connector from FIG. 7 according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

FIG. 1 shows a schematic representation of a module connector 10 according to an exemplary embodiment of the invention. The module connector 10 is shown on the one hand on the right side in FIG. 1 in a cross-sectional view and on the left side in FIG. 1 in an exploded view. The module connector 10 is designed to produce an electrically conductive plug connection with a module pole connection 12 (cf. FIG. 3 and FIG. 4) in a connecting direction R which is aligned parallel to an axis A of the module connector 10. The connecting direction R can also be referred to as the axial direction. A radial direction is defined perpendicular to this axis A.

The module connector 10 comprises an electrically conductive busbar 14. This in turn has a busbar through-opening 14a. In addition, the module connector 10 has an electrically conductive contact socket 16. This also has a socket opening 16a in the form of a through opening 16a in the connecting direction R. The contact socket 16 is arranged in the connecting direction R below the busbar 14, in such a way that the busbar through-opening 14a and the socket opening 16a are coaxially oriented or aligned with each other. Thus, a fastening means 18, in this example a screw 20 with its screw neck 20a can be passed through both openings 14a, 16a at the same time. In addition to a screw neck 20a, the screw 20 also comprises a head 20b. This is widened in the radial direction compared to the screw neck 20a. Optionally, a washer, in particular a metallic washer 22, can also be provided. This serves to distribute the pressure more evenly via the screw head 20b onto the busbar 14. Furthermore, the module connector 10 comprises a housing 24, which in this example comprises an upper housing part 26 and a lower housing part 28. These can, for example, be clipped together to form the housing 24. The lower housing part 28 can be further divided into individual regions and, for example, comprise an insulation collar 28a which surrounds at least part of the contact socket 16 and the busbar 14 in the radial direction. The remaining parts of the housing 24 serve mainly to enclose the busbar 14 in an electrically insulating manner. The upper housing part 26 can also have a through-opening 26a in the region of the screw head 20b to allow access for a screwing tool.

The module connector 10 in this example now advantageously has a spring element 30 in the form of a spiral spring 32. This surrounds the screw neck 20a in the radial direction. In addition, this spring 32 is located between the contact socket 16 and the screw head 20b. The spring 32 is also passed through the busbar through-opening 14a and also inserted a little way into the socket opening 16a. In this example, the contact socket 16 has a support flange 16b which projects radially inwards into the socket opening 16a and on which the spring 32 is supported downwards with a spring end 32a, so that the spring 32 cannot fall downwards, i.e. in the connecting direction R through the contact socket 16.

The opposite second end 32b of the spring 32 is supported by the washer 22 in this example. If this is not present, the spring 32 can be supported analogously on the screw head 20b. Furthermore, the module connector 10 comprises an insulating sleeve 34. This is arranged in the busbar through-opening 14a and insulates the busbar 14 from the screw 20 and the spring 32. The sleeve 34 can be clipped into the through-opening 14a of the busbar 14, for example. The sleeve 34 can be held in the opening 14a in a frictional and/or positive manner.

In addition, the insulation collar 28a also comprises a mounting flange 28b which projects radially inward, and the contact socket 16 has a support flange 16c which rests on the support flange 28b of the housing 28. As a result, the contact socket 16 can be held in the housing 26, in particular in the insulation collar 28a, and falling out downwards, i.e. in the connecting direction R, can be prevented.

By providing this spring 32, it is now advantageously possible for the contact socket 16, and additionally in this example also the screw 20, to be electrically insulated from the busbar 14 in a first state Z1 of the module connector 10, which is shown in FIG. 1. The spring 32 holds the contact socket 16 at a certain distance from the busbar 14, so that there is no electrically conductive contact between the contact socket 16 and the busbar 14. Correspondingly, the spring 32 also holds the screw 20, in particular the screw head 20b, at a certain distance from the busbar 14, so that there is no electrically conductive contact between the screw 20 and the busbar 14. The insulating sleeve 34 also ensures electrical insulation between the spring 32 and the screw neck 20a on the one hand and the busbar 14 on the other hand. In this first state Z1 shown here, both the screw 20 and the contact socket 16 can be touched safely, since even if the busbar 14 is live, there is no electrically conductive contact with the screw 20 and the contact socket 16.

The contact socket 16 has an insulation-free socket part 16d which comprises the end face 16e of the contact socket 16, wherein the end face 16e simultaneously provides a contact surface 36. This socket part 16d projects beyond the housing 26, in particular the insulation collar 28a, in the connecting direction R, at least in the first state Z1 and in particular also in the second state Z2, albeit to a reduced extent. In other words, the insulation-free socket part 16d protrudes from the housing 16. This in turn enables a significantly simpler design of the corresponding module pole connection 12, as explained in more detail below. In this example, touching the contact socket 16 does not pose any risk of electric shock, since the contact socket 16 is electrically insulated from the busbar 14 in the first state Z1. In this example, the screw 20 could also protrude a little further down from the contact socket 16 without the need for additional touch protection. The screw 20 is also electrically insulated from the busbar 14 in the first state Z1 of the module connector 10.

FIG. 2 again shows a schematic and perspective representation of the module connector 10 from FIG. 1.

FIG. 3 shows a schematic representation of a module pole connection 12 according to an exemplary embodiment of the invention, and FIG. 4 shows the module pole connection 12 from FIG. 3 in a schematic cross-sectional representation. This module pole connection 12 is designed to be electrically contacted with a module connector 10, as previously described, in particular via a plug connection in the plug direction R.

The module pole connection 12 also has a busbar 37, namely a module pole busbar 37. In addition, the module pole connection 12 comprises a housing 38 which encloses the busbar 37. The busbar 37 also has a contact region 37a which can be electrically contacted with the contact surface 36 of the module connector 10 and is contacted when the module pole connection 12 is connected to the module connector 10 as intended. The housing 38 now advantageously has a housing wall 40 with a recess region 40a, which has at least one recess 42 for exposing at least part of the contact region 37a of the module pole busbar 37. In addition, the housing wall 40 comprises a recess edge region 44 which encloses the recess region 40a in the radial direction relative to a central axis A'. In addition, the housing wall 40 comprises, radially within the recess region 40a, an electrically insulating insulation ring 46 which is connected to the recess edge region 44 via at least one insulation web 48, in the present example two insulation webs 48.

The recess edge region 44, the insulation ring 46 and the insulation webs 48 can be designed to be slightly elevated relative to the surrounding housing wall 40. However, this elevation is in the order of magnitude of the wall thickness of the housing wall 40, as can be seen in FIG. 4. In other words, this design does not require a great deal of installation space in the axial direction A'. The touch protection is made possible by the insulating webs 28. As a result, the exposed regions 37a are segmented into smaller sub-regions. In principle, further webs 48 can be provided between the surrounding edge region 44 and the insulation ring 46, and a total of, for example, three or four or more webs 48 can be provided. This makes it particularly easy to provide touch protection. Contacting to the module connector 10 can also be provided particularly easily by the fact that the contact socket 16 protrudes from the housing 24 with its insulation-free socket part 16d. Thus, a complex geometry of the module pole connection 12 can be dispensed with in order to enable contact with the contact socket 16.

FIG. 5 shows a schematic and perspective representation of a connecting assembly 50 having a module connector 10 and a module pole connection 12 in a mutually connected state according to an exemplary embodiment of the invention. The module connector 10 and the module pole connection 12 can be designed as previously described. FIG. 6 shows again the connecting assembly 50 in a schematic cross-sectional view. The module connector 10 is here in a second state Z2, in which the spring 32 is now compressed or at least further compressed than in the first state Z1, which is shown in FIG. 1. In this second state Z2, there is now an electrically conductive contact between the contact socket 16 and the busbar 14, as well as between the screw 20, in particular the screw head 20b, the washer 22 and the busbar 14. The transition from the first state Z1 to the second state Z2 is achieved in a simple manner by the module connector 10 being plugged onto the module pole connection 12 in the connecting direction R as intended and then the screw 20 being screwed into the corresponding nut 52, which is provided as part of the module pole connection 12. This nut 52 can also be flanged to the busbar 37 in the region of a through-opening 54 of this busbar 37, or pressed in, welded on or fastened in some other way. The nut 52 can, for example, be made of steel, while the busbar 37 is preferably made of copper. In particular, busbar 37 and nut 52 can be made of different materials. As a result, the busbar 37 can be designed to be very conductive, while the nut 52 can provide the necessary stability and holding force for the screw 20. Thus, if the screw 20 is screwed into the nut 52, the screw head 20b moves correspondingly downwards, i.e. in the connecting direction R, while, for example, the contact socket 16, which rests on the module pole connection 12, is held in position. This reduces the distance between the screw head 20b and the contact socket 14, which compresses the spring 32. This results in contact between screw 20, busbar 14 and contact socket 16.

In addition, the contact socket 16 can be designed with slots 56 on its end face 16e (see FIG. 2). The corresponding webs 48 of the module pole connection 12 can then be accommodated therein. The touch protection at the module pole, i.e. at the module pole connection 12, can therefore be realized by the geometry of the insulated housing 38. Due to the design of the high-voltage connector described here, i.e. the module connector 10, no further components are required on the module pole, i.e. on the module pole connection 12, to ensure touch protection. With this implementation of the touch protection on the module connector 10, the touch protection on the module pole 12 of the high-voltage battery can be implemented very easily and with few individual parts. The high-voltage connector 10 can also be designed to be touch-protected. The touch protection on the high-voltage connector 10 is advantageously realized by an integrated spring element 30. In the first state Z1, the contact socket 16 and the connecting element, that is to say the fastening means 18, 20 and, if present, the disk 22, are held away from the busbar 14 by a spring element 30, as a result of which the contact socket 16 and the connecting element 18 have no electrical connection to the busbar and are therefore touch-protected, or the module connector 10 as a whole can be regarded as being designed to be touch-protected. When connecting the high-voltage connector 10 to the electrical interface, i.e. the module pole connection 12, of the battery, the contact socket 16 is connected to the busbar 14 and pressed. This ensures electrical contact when assembled. The electrically insulating housing of both the module connector 10 and the module pole connection 12 also provides touch protection when assembled.

Although the contact socket 16 on the high-voltage connector 10 protrudes beyond the housing 26 when not mounted, the touch protection is provided by the spring element 30. This allows the module pole 12 to be designed to be touch-protected simply and with few components. No additional insulation of the connecting elements on the module pole 12 or on the HV connector 10 is necessary, and the touch protection is provided by the existing housing 26, 38. Standard connecting elements, such as screws, washers, press-in nuts, can advantageously be used for screwing.

FIG. 7 shows a schematic representation of a module connector 10′ according to a further embodiment of the invention in a cross-sectional representation, and FIG. 8 shows a schematic representation of a connecting assembly 50′ according to a further embodiment of the invention, which comprises the module connector 10′ according to FIG. 7. In this example, the previously described spring element 30 has been omitted. In particular, the module connector 10′ can be designed as described above, except for the differences described below. In this example, the screw 20 on the one hand and the contact socket 16 on the other hand have permanent electrically conductive contact with the busbar 14. The module connector 10 therefore does not have a first and second state as previously described. The insulation sleeve 34 can also be omitted. In this case too, the contact socket 16 projects slightly downwards, i.e. in the connecting direction R, from the housing 24, in particular from the insulation collar 28a of the lower housing part 28.

However, the module pole connection 12 to which this module connector 10′ can be coupled can be designed as previously described. In other words, this module connector 10′ can also be connected with electrical contact, for example, to a module pole connection 12 as shown in FIG. 3 and FIG. 4. FIG. 8 shows the module connector 10′ in a state coupled to such a module pole connection 12. This embodiment of the module connector 10′ also advantageously enables a very simple design of the module pole connection 12. However, in the non-assembled state, as shown in FIG. 7, there is no touch protection for the lower part of the screw 20 and the contact socket 16. Such a module connector 10′ is suitable, for example, for installation situations which themselves provide appropriate touch protection, i.e., which make contact with the screw 20 and/or the contact socket 16 impossible from an installation space perspective, or for installation situations in which the busbar 14 is not yet live. However, in the assembled state, as shown in FIG. 8, the touch protection is again ensured by the housings 24, 38.

Overall, the examples show how the invention can provide a touch protection interface for high-voltage connectors and high-voltage batteries according to advantageous embodiments.

1-10. (canceled)

11. A module connector for electrically connecting to a module pole connection of a battery module by producing a plug connection in a connecting direction, wherein the module connector comprises:
an electrically conductive busbar with a busbar through-opening for passing through a fastener in the connecting direction;
an electrically conductive contact socket having a socket part with an insulation-free end face providing a contact surface for electrically contacting the module pole connection, wherein the contact socket has a socket opening which is arranged below the busbar and coaxially aligned with the busbar through-opening with respect to the connecting direction, so that the fastener can be passed through the busbar through-opening and the socket opening simultaneously in the connecting direction; and
an electrically insulating housing with an insulation collar that surrounds at least a part of the busbar and at least a part of the contact socket in a radial direction;
wherein the insulation-free socket part of the contact socket, which comprises the end face with the contact surface, protrudes from the housing in the connecting direction,
wherein the module connector has a slot-like recess on the end face of the contact socket.

12. The module connector according to claim 11, wherein the module connector has an elastic spring element which is compressible and/or expandable in the connecting direction,
wherein the module connector can be transferred from a first state to a second state,
wherein in the first state the contact socket is held at a distance from the busbar and is electrically insulated from it by means of the spring element, and in the second state it rests against the busbar in an electrically contacting manner under compression of the spring element.

13. The module connector according to claim 12, wherein the module connector comprises an insulation sleeve made of an electrically insulating material, wherein the insulation sleeve is arranged in the busbar through-opening, in particular on an opening wall delimiting the busbar through-opening in the radial direction, wherein the fastening means is electrically insulated from the busbar by means of the insulation sleeve when passed through the busbar through-opening, in particular wherein the spring element is designed as a spiral spring which is passed through the busbar through-opening and is electrically insulated from the busbar by means of the insulation sleeve.

14. The module connector according to claim 12, wherein the contact socket has a radially inwardly projecting support flange on which the spring element is supported in the connecting direction with a first spring end.

15. The module connector according to claim 12, wherein the module connector comprises the fastener, which comprises a fastening means elongated in the connecting direction with a head and a neck adjoining the head in the connecting direction, wherein the neck is passed through the busbar through-opening and the socket opening, and wherein the fastening means has an end opposite the head, in particular protruding from the housing in the connecting direction.

16. The module connector according to claim 15, wherein the first state of the module connector, the head is held at a distance from the busbar and electrically insulated from the busbar by the spring element, and in the second state is electrically conductively connected to the busbar, in particular rests directly on the busbar, or the module connector comprises a metallic washer which is arranged between the head and the busbar and via which the head and the busbar are electrically conductively connected to each other in the second state.

17. The module connector according to claim 11, wherein the contact socket is arranged in permanent electrical contact with the busbar and/or is formed integrally therewith, and in particular wherein the fastener is permanently electrically conductively connected to the busbar.

18. The module connector according to claim 15, wherein the spring element has a second spring end which is supported on the head of the fastener and/or on the washer, in particular wherein the spring element can be compressed by moving the head of the fastener in the connecting direction while the contact socket remains in its position, and the modular connector can be transferred from the first state to the second state.

19. A module pole connection for electrically connecting to a module connector according to claim 11, wherein
the module pole connection has a module pole busbar with a contact region, which can be electrically contacted in the connecting direction with the contact surface of the module connector, and
a housing which is of electrically insulating design and in which the module pole busbar is accommodated,
wherein the housing has a housing wall, which has a recess region with at least one recess for exposing at least part of the contact region of the module pole busbar,
wherein the housing wall has a recess edge region surrounding the recess region in a radial direction, and
wherein the housing wall comprises an electrically insulating insulation ring radially within the recess region, which is connected to the recess edge region via at least one insulation web.

20. A connecting assembly for a battery module, wherein the connecting assembly comprises a module connector and a module pole connection according to claim 19.

21. The module connector according to claim 13, wherein the contact socket has a radially inwardly projecting support flange on which the spring element is supported in the connecting direction with a first spring end.

22. The module connector according to claim 11, wherein the module connector comprises the fastener, which comprises a fastening means elongated in the connecting direction with a head and a neck adjoining the head in the connecting direction, wherein the neck is passed through the busbar through-opening and the socket opening, and wherein the fastening means has an end opposite the head, in particular protruding from the housing in the connecting direction.

23. The module connector according to claim 13, wherein the module connector comprises the fastener, which comprises a fastening means elongated in the connecting direction with a head and a neck adjoining the head in the connecting direction, wherein the neck is passed through the busbar through-opening and the socket opening, and wherein the fastening means has an end opposite the head, in particular protruding from the housing in the connecting direction.

24. The module connector according to claim 14, wherein the module connector comprises the fastener, which comprises a fastening means elongated in the connecting direction with a head and a neck adjoining the head in the connecting direction, wherein the neck is passed through the busbar through-opening and the socket opening, and wherein the fastening means has an end opposite the head, in particular protruding from the housing in the connecting direction.

25. The module connector according to claim 15, wherein the contact socket is arranged in permanent electrical contact with the busbar and/or is formed integrally therewith, and in particular wherein the fastener is permanently electrically conductively connected to the busbar.

26. The module connector according to claim 16, wherein the contact socket is arranged in permanent electrical contact with the busbar and/or is formed integrally therewith, and in particular wherein the fastener is permanently electrically conductively connected to the busbar.

27. The module connector according to claim 23, wherein the spring element has a second spring end which is supported on the head of the fastener and/or on the washer, in particular wherein the spring element can be compressed by moving the head of the fastener in the connecting direction while the contact socket remains in its position, and the modular connector can be transferred from the first state to the second state.

28. The module connector according to claim 24, wherein the spring element has a second spring end which is supported on the head of the fastener and/or on the washer, in particular wherein the spring element can be compressed by moving the head of the fastener in the connecting direction while the contact socket remains in its position, and the modular connector can be transferred from the first state to the second state.
